(19) United States
(12) Patent Application Publication
(10) Pub. No.: US 2018/0368615 A1
(43) Pub. Date: Dec. 27, 2018

(54) SPLIT ELECTRIC RICE COOKER

(71) Applicant: FOSHAN SHUNDE MIDEA ELECTRICAL HEATING APPLIANCES MANUFACTURING CO., LIMITED, Foshan (CN)

(72) Inventors: Zhixiao LUO, Foshan (CN); Chuanbin Zhu, Foshan (CN); Xianhuai Chen, Foshan (CN); Zhengting Fu, Foshan (CN); Linbo Zhu, Foshan (CN); Wei Yuan, Foshan (CN); Wei Chen, Foshan (CN); Yuquan Wu, Foshan (CN)

(21) Appl. No.: 16/121,649

(22) Filed: Sep. 5, 2018

Related U.S. Application Data
(63) Continuation of application No. PCT/CN2017/117263, filed on Dec. 19, 2017.

(30) Foreign Application Priority Data
Mar. 31, 2017 (CN) 201720340935.3

(51) Int. Cl. A47J 36/34; A47J 27/00; A47J 27/12; A47J 27/082; A47J 36/16; A47J 36/06

(52) U.S. Cl. CPC A47J 36/34; A47J 27/004; A47J 36/06; A47J 27/082; A47J 36/16; A47J 27/12

(57) ABSTRACT

A split electric rice cooker includes a base, a cooker body, a weighing device, and a press cover. The weighing device includes a weighing sensor and a support leg. The weighing sensor includes a body portion and a cantilever weighing portion. The support leg penetrates downwards through the press cover. A limiting plate is provided in a weighing-device mounting groove of the base. When the cantilever weighing portion is bent upwards and deformed with respect to the body portion, the limiting plate is apt to abut against the cantilever weighing portion to limit a position of the cantilever weighing portion; or the support leg is provided with a limiting portion, and the limiting portion is apt to move with respect to the body portion along with the support leg to abut against a bottom surface of the body portion.

### CROSS-REFERENCE TO RELATED APPLICATIONS

This application is a continuation of International Application PCT/CN2017/117263, filed Dec. 19, 2017, which claims the priority of Chinese Patent Application No. 201720340935.3 and Chinese Patent Application No. 201720340885.9, both filed with the State Intellectual Property Office of P. R. China on Mar. 31, 2017, the entire content of which are incorporated herein by reference.

### FIELD

The present disclosure relates to a technical field of household appliances, and specifically to a split electric rice cooker.

### BACKGROUND

In the related art, small home appliances have been popularized in people's lives, and each family basically possesses an electric rice cooker, an induction cooker and other household appliances. More and more products may be placed in a kitchen with product diversification. In order to reduce household appliances and thus reduce their occupation of the kitchen space, the electric rice cooker and the induction cooker can be integrated into a split electric rice cooker. An existing split electric rice cooker is only provided with a simple weighing device, and when a lot of food is placed in a cooker body, a maximum range of the weighing device will be exceeded, causing a weighing module to be damaged and causing a weighing function to fail.

### SUMMARY

The present disclosure seeks to solve one of the above technical problems existing in the related art to at least some extent. Thus, the present disclosure proposes a split electric rice cooker that is able to provide overload protection for a weighing sensor.

The split electric rice cooker according to embodiments of the present disclosure includes: a base provided with a weighing-device mounting groove at a bottom thereof, a limiting plate being provided in the weighing-device mounting groove; a cooker body apt to rest on the base and separable with respect to the base; a weighing device provided in the weighing-device mounting groove, and including a weighing sensor and a support leg connected with the weighing sensor, the weighing sensor being fixed in the weighing-device mounting groove and including a body portion and a cantilever weighing portion, the cantilever weighing portion being provided to the body portion, the cantilever weighing portion being located below the limiting plate, and when the cantilever weighing portion being bent upwards and deformed with respect to the body portion, the limiting plate being apt to abut against the cantilever weighing portion to limit a position of the cantilever weighing portion; and a press cover provided to the bottom of the base and shielding the weighing-device mounting groove, the press cover being provided with a press-cover clearance hole for the support leg to pass downwards.

The split electric rice cooker according to embodiments of the present disclosure can provide overload protection for the weighing sensor, thereby prolonging service life of the weighing sensor.

In addition, the split electric rice cooker according to embodiments of the present disclosure can further have the additional technical features as follows.

According to some embodiments of the present disclosure, a support plate and a vertical snapping plate are provided in the weighing-device mounting groove, and the weighing sensor is sandwiched between the vertical snapping plate and the support plate.

According to some embodiments of the present disclosure, the support plate includes: a first support plate, a second support plate, a third support plate, and a fourth support plate; the first support plate, the second support plate, the third support plate, and the fourth support plate are provided to a first side wall, a second side wall, a third side wall and a fourth side wall of the weighing-device mounting groove respectively; the first side wall, the second side wall, the third side wall and the fourth side wall are connected successively.

According to some embodiments of the present disclosure, the body portion is an annular frame body, and the cantilever weighing portion is provided within the body portion.

According to some embodiments of the present disclosure, the cantilever weighing portion includes a first cantilever and a second cantilever; the first cantilever is T-shaped and includes a transverse section and a longitudinal section; the longitudinal section is connected with the body portion, and two ends of the transverse section are separately provided with the second cantilever.

According to some embodiments of the present disclosure, the body portion includes: a first frame bar, a second frame bar, a third frame bar, and a fourth frame bar connected successively; the first frame bar is adjacent to the transverse section; the first frame bar, the second frame bar, the third frame bar, and the fourth frame bar are apt to abut against the first support plate, the second support plate, the third support plate, and the fourth support plate respectively.

According to some embodiments of the present disclosure, the first support plate has an inverted three-step structure; the third support plate has an inverted two-step structure; the first frame bar is apt to abut against a bottom surface of a second step of the first support plate; the transverse section is suspended below a bottom surface of a first step of the first support plate; the first step of the first support plate constitutes the limiting plate; and the third frame bar is apt to abut against a bottom surface of a first step of the third support plate.

According to some embodiments of the present disclosure, the bottom surface of the second step of the first support plate is flush with the bottom surface of the first step of the third support plate.

According to some embodiments of the present disclosure, a third step of the first support plate and a second step of the third support plate clamp and respectively abut against the first frame bar and the third frame bar, so as to limit the position of the body portion in a direction parallel to the longitudinal section.

According to some embodiments of the present disclosure, a bottom surface of the third step of the first support plate and a bottom surface of the second step of the third support plate are each configured as a guide bevel.

According to some embodiments of the present disclosure, the second support plate and the fourth support plate are respectively located outside the second cantilevers of the corresponding sides to evade the second cantilevers.

According to some embodiments of the present disclosure, a limiting protrusion is provided on each of the second support plate and the fourth support plate, and the limiting protrusion on the second support plate and the limiting protrusion on the fourth support plate clamp and respectively abut against the second frame bar and the fourth frame bar, so as to limit the position of the body portion in a direction parallel to the transverse section.

According to some embodiments of the present disclosure, each of the second support plate and the fourth support plate is divided into two sections spaced apart from each other, and one vertical snapping plate is disposed between the two sections.

According to some embodiments of the present disclosure, the bottom of the base is further provided with an catching groove, the press cover is further provided with a pre-assembled catching portion, and the pre-assembled catching portion is engaged within the catching groove.

According to some embodiments of the present disclosure, the press cover is further fastened to the bottom of the base through a press-cover threaded assembly.

According to some embodiments of the present disclosure, a distance between the cantilever weighing portion and the limiting plate is L, deformation displacement of the cantilever weighing portion with respect to the body portion is associated with the weight to be weighed, and the deformation displacement of the cantilever weighing portion is S when the weighing sensor 510 is in a maximum range, in which L≤S.

According to some embodiments of the present disclosure, the press cover and the support leg are integrally formed, and the support leg is supported on a bottom surface of the cantilever weighing portion and is able to be deformed along with the press cover and push the cantilever weighing portion upwards

According to some embodiments of the present disclosure, the weighing sensor is provided with a mounting hole, an upper surface of the support leg is fixed with a fixing column, the fixing column is provided through the mounting hole and has an upper end formed with a diameter-enlarged portion, and a radial dimension of the diameter-enlarged portion is larger than a radial dimension of the mounting hole, such that the weighing sensor is clamped and fixed between the diameter-enlarged portion and the support leg.

The weighing device according to embodiments of the present disclosure includes: a weighing sensor including a body portion and a cantilever weighing portion, the cantilever weighing portion being provided to the body portion; a support leg supported on a bottom surface of the cantilever weighing portion and fixed with the cantilever weighing portion; a limiting portion provided on the support leg and located below the body portion, the limiting portion being apt to move upwards with respect to the body portion along with the support leg to abut against a bottom surface of the body portion.

The weighing device according to embodiments of the present disclosure can prevent the weighing sensor from being overloaded and failing, and prolong service life of the weighing sensor.

In some embodiments of the present disclosure, a distance between the limiting portion and the body portion is L, deformation displacement of the cantilever weighing portion with respect to the body portion is associated with the weight to be weighed, and the deformation displacement of the cantilever weighing portion is S when the weighing sensor is in a maximum range, in which L≤S.

In some embodiments of the present disclosure, the body portion is an annular frame body, and the cantilever weighing portion is provided within the body portion.

In some embodiments of the present disclosure, the cantilever weighing portion includes a first cantilever and a second cantilever; the first cantilever is fixed with the body portion; the second cantilever is fixed with the first cantilever and also fixed with the support leg.

In some embodiments of the present disclosure, the second cantilever is located at each of two sides of the first cantilever.

In some embodiments of the present disclosure, the first cantilever is T-shaped and includes a transverse section and a longitudinal section, and two ends of the transverse section are separately provided with the second cantilever.

In some embodiments of the present disclosure, the support leg includes a support-leg body and a support block provided to the support-leg body, the support block being fixed with the second cantilever.

In some embodiments of the present disclosure, respective lower surfaces of the first cantilever and the second cantilever are flush with each other, and both abut against an upper surface of the support block.

In some embodiments of the present disclosure, the second cantilever is provided with a mounting hole; the weighing device further includes a weighing-device threaded fastener, and the weighing-device threaded fastener is fixed by being threaded with the support block after passing through the mounting hole from the top downwards.

In some embodiments of the present disclosure, a distance between facing-away outer sides of the two second cantilevers is greater than or equal to a transverse length of the support block.

In some embodiments of the present disclosure, the limiting portion is provided to an end face of each of two transverse ends of the support block.

In some embodiments of the present disclosure, a hollowed groove is defined between the body portion and the second cantilever, and an outer side surface of the limiting portion is outside an outer edge of the hollowed groove.

In some embodiments of the present disclosure, the second cantilevers at two sides of the first cantilever are arranged symmetrically, and the first cantilever is spaced apart from and arranged parallel to the second cantilever.

The split electric rice cooker according to embodiments of the present disclosure includes the weighing device.

In some embodiments of the present disclosure, the split electric rice cooker further includes: a base provided with a weighing-device mounting groove at a bottom thereof, the weighing sensor being fixed in the weighing-device mounting groove; a cooker body apt to rest on the base and separable with respect to the base; a press cover provided to the bottom of the base and shielding the weighing-device mounting groove. The press cover is integrally formed with the support leg, the support leg is supported on a bottom surface of the cantilever weighing portion, and the support leg can be deformed along with the press cover and push the cantilever weighing portion upwards; or the press cover is provided with a press-cover clearance hole for the support leg to pass downwards.

In some embodiments of the present disclosure, the weighing sensor is provided with a mounting hole, an upper surface of the support leg is fixed with a fixing column, the fixing column is provided through the mounting hole and has an upper end formed with a diameter-enlarged portion, and a radial dimension of the diameter-enlarged portion is larger than a radial dimension of the mounting hole, such that the weighing sensor is clamped and fixed between the diameter-enlarged portion and the support leg.

Embodiments of present disclosure will be given in part in the following descriptions, become apparent in part from the following descriptions, or be learned from the practice of the embodiments of the present disclosure.

### BRIEF DESCRIPTION OF THE DRAWINGS

FIG. 1 is a schematic view of a split electric rice cooker according to embodiments of the present disclosure.

FIG. 2 is a partially enlarged view of FIG. 1.

FIG. 3 is a bottom schematic view of a split electric rice cooker according to an embodiment of the present disclosure, with a part of press covers being removed.

FIG. 4 is a partially enlarged view of FIG. 3.

FIG. 5 is a sectional schematic view of a split electric rice cooker according to an embodiment of the present disclosure.

FIG. 6 is a schematic view of a press cover and a support leg of a split electric rice cooker according to another embodiment of the present disclosure.

FIG. 7 is an assembly schematic view of a weighing sensor and a support leg according to an embodiment of the present disclosure.

FIG. 8 is an exploded schematic view of a weighing device according to an embodiment of the present disclosure.

FIG. 9 is a sectional schematic view of a weighing device according to an embodiment of the present disclosure.

FIG. 10 is another schematic view of a weighing device according to an embodiment of the present disclosure.

FIG. 11 is a partial schematic view of a split electric rice cooker according to embodiments of the present disclosure.

FIG. 12 is a partially enlarged view of area A circled in FIG. 11.

FIG. 13 is a partially exploded schematic view of a split electric rice cooker according to an embodiment of the present disclosure.

FIG. 14 is a schematic view of a press cover and a support leg of a split electric rice cooker according to an embodiment of the present disclosure.

### REFERENCE NUMERALS

split electric rice cooker 1000, base 100, weighing-device mounting groove 120, first side wall 121, second side wall 122, third side wall 123, fourth side wall 124, first support plate 131, second support plate 132, third support plate 133, fourth support plate 134, vertical snapping plate 140, limiting plate 160,
cooker body 200, base plate 210, base-plate through hole 214, pot body 220, inner-pot heat insulation piece 230, bottom-wall protrusion 234,
weighing device 500,
weighing sensor 510, body portion 511, cantilever weighing portion 512, first cantilever 5121, transverse section 5121a, longitudinal section 5121b, second cantilever 5122, mounting hole 5122a, hollowed groove 513,
support leg 520, support-leg body 521, support block 522, limiting portion 524, fixing column 523, diameter-enlarged portion 5231,
weighing-device threaded fastener 530,
press cover 600, press-cover clearance hole 601, weakening groove 603.

### DETAILED DESCRIPTION

The embodiments of the present disclosure are described in detail below, and examples of the embodiments are shown in the accompanying drawings, in which the same or similar reference numerals denote the same or similar elements or elements having the same or similar functions throughout. The embodiments described herein with reference to drawings are explanatory, illustrative, and used to generally understand the present disclosure, and should not be construed to limit the present disclosure.

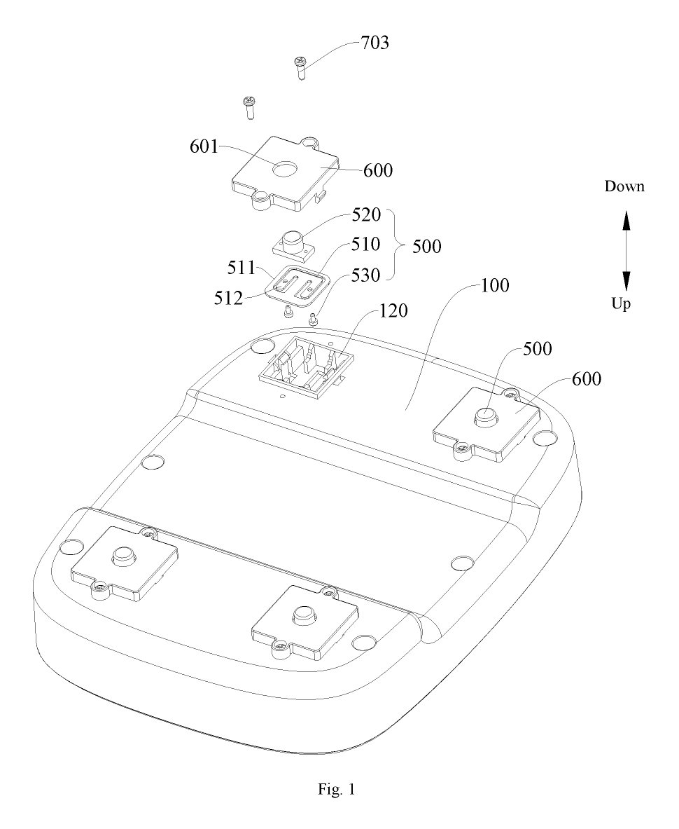

A split electric rice cooker 1000 according to embodiments of the present disclosure will be described in detail with reference to FIG. 1 to FIG. 7.

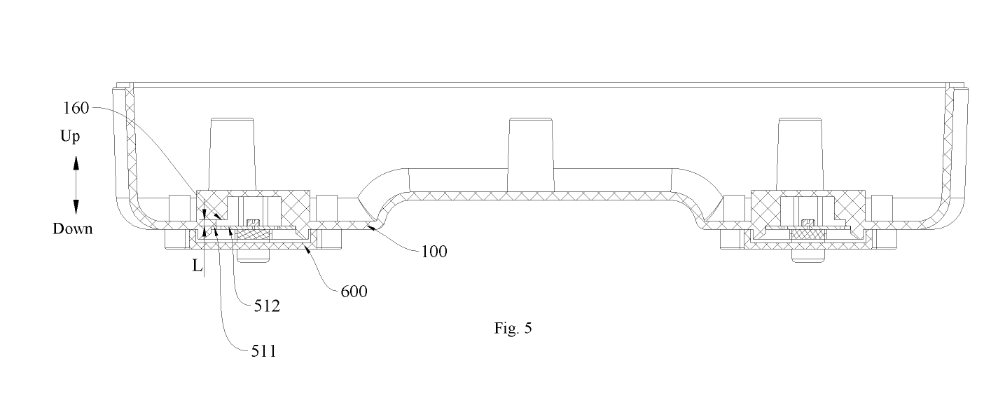

As illustrated in FIG. 1, the split electric rice cooker 1000 according to embodiments of the present disclosure includes a base 100, a cooker body 200, a weighing device 500 and a press cover 600. The base 100 is provided with a weighing-device mounting groove 120 at the bottom thereof, a limiting plate 160 is provided in the weighing-device mounting groove 120 (see FIG. 5), the cooker body is apt to rest on the base 100 and is separable with respect to the base 100, and the weighing device 500 is provided in the weighing-device mounting groove 120.

The weighing device 500 includes a weighing sensor 510 and a support leg 520 connected with the weighing sensor 510. The weighing sensor 510 is fixed in the weighing-device mounting groove 120 and includes a body portion 511 and a cantilever weighing portion 512. The cantilever weighing portion 512 is provided to the body portion 511, and the cantilever weighing portion 512 is located below the limiting plate 160. The press cover 600 is provided at the bottom of the base 100 and shields the weighing-device mounting groove 120, and the press cover 600 is provided with a press-cover clearance hole 601 for the support leg 520 to pass downwards. When the cantilever weighing portion 512 is bent upwards and deformed with respect to the body portion 511, the limiting plate 160 is apt to abut against the cantilever weighing portion 512 to limit the position of the cantilever weighing portion 512.

For the split electric rice cooker according to embodiments of the present disclosure, by providing the limiting plate 160 in the weighing-device mounting groove 120, when the cooker body is overweight, the limiting plate 160 limits the position of the cantilever weighing portion 512 to prevent the cantilever weighing portion 512 from continuing to generate relative deformation with respect to the body portion 511, so as to provide overload protection for the weighing sensor 510 and guarantee normal use of the weighing function.

It should be noted that only when the weight applied to the body portion 511 exceeds a tolerable range of the weighing sensor 510, the limiting plate 160 abuts against a bottom surface of the body portion 511; when the weighing sensor 510 is in normal use, the limiting plate 160 moves towards the body portion 511 and remains at a certain balanced position, in which case the limiting plate 160 is spaced apart from the bottom surface of the body portion 511 by a certain distance. Thus, the weighing sensor 510 can be prevented from failure due to overloading, while the normal use thereof can be ensured.

In the split electric rice cooker according to an embodiment of the present disclosure, a support plate and a vertical snapping plate 140 are provided in the weighing-device mounting groove 120, and the weighing sensor 510 is sandwiched between the vertical snapping plate 140 and the support plate. Therefore, the weighing sensor 510 is fastened by the support plate and the vertical snapping plate 140 together provided in the weighing-device mounting groove 120, such that not only the structure becomes simple and compact, but also the disassembly is convenient.

The vertical snapping plate 140 can fasten the weighing sensor 510 in a vertical direction, and the vertical snapping plate 140 and the support plate together can limit the weighing sensor 510 in a horizontal direction to prevent the weighing sensor 510 from rotating.

According to some embodiments of the present disclosure, the support plate includes a first support plate 131, a second support plate 132, a third support plate 133, and a fourth support plate 134. The first support plate 131, the second support plate 132, the third support plate 133, and the fourth support plate 134 are provided to a first side wall 121, a second side wall 122, a third side wall 123 and a fourth side wall 124 of the weighing-device mounting groove 120 respectively, in which the first side wall 121, the second side wall 122, the third side wall 123 and the fourth side wall 124 are connected successively.

Specifically, the weighing-device mounting groove 120 exhibits a substantially square groove, the first side wall 121 and the third side wall 123 of the weighing-device mounting groove 120 are opposite, the second side wall 122 and the fourth side wall 124 thereof are opposite, and the first to fourth side walls are provided with the first to fourth support plates respectively. An upper surface of the weighing sensor 510 is opposite to respective lower surfaces of the first to fourth support plates, and a lower surface of the weighing sensor 510 abuts against a snap hook of the vertical snapping plate 140, so as to limit the position of the weighing sensor 510 in the vertical direction; respective side surfaces of the first to fourth side walls abut against an outer edge of the weighing sensor 510, so as to limit the position of the weighing sensor 510 in the horizontal direction.

Therefore, the horizontal limiting of the weighing sensor 510 is achieved through the first to fourth support plates, to effectively prevent horizontal rotation of the weighing sensor 510, and enhance stability and reliability of the weighing sensor 510 fixed in the weighing-device mounting groove 120.

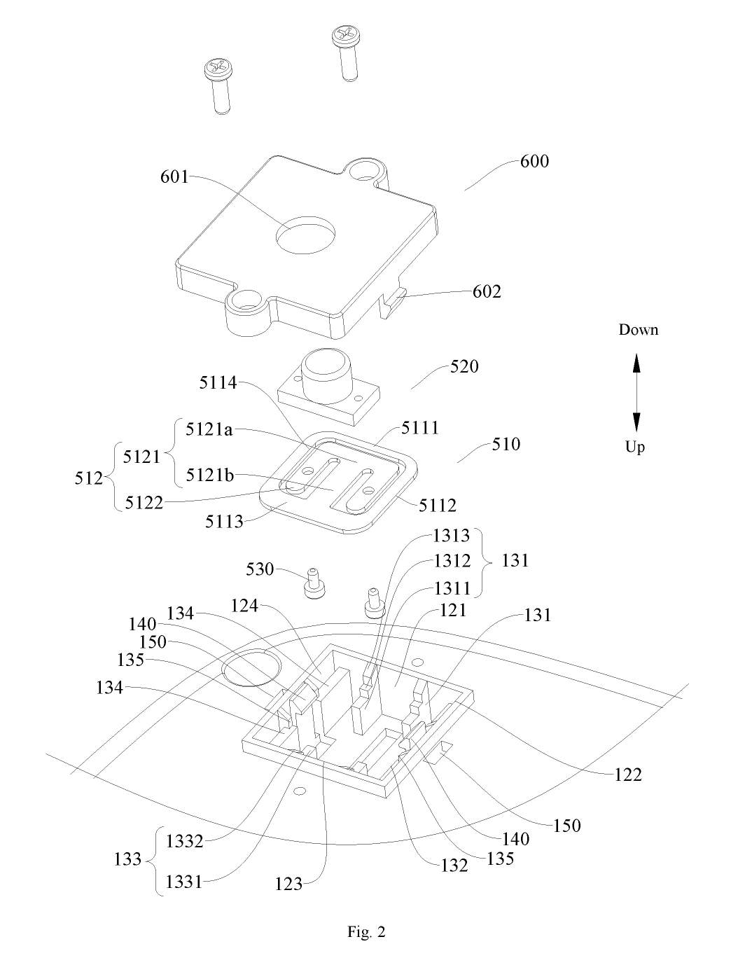

According to some embodiments of the present disclosure, the weighing sensor 510 includes the body portion 511 and the cantilever weighing portion 512. The body portion 511 is an annular frame body, and the cantilever weighing portion 512 is provided inside the body portion 511. Specifically, as illustrated in FIG. 2, the cantilever weighing portion 512 is connected with a part of an inner edge of the body portion 511, the support leg 520 is fixedly connected with a cantilever support portion, and the body portion 511 and the weighing-device mounting groove 120 are fixedly connected.

In this way, the support leg 520 of the base 100 is placed on the ground, and then the cooker body is placed on the base 100; since the weight imposed on the body portion 511 increases (i.e. the added weight of the cooker body), the body portion 511 moves downwards under the action of weight increase and drives the cantilever weighing portion 512 to produce elastic deformation; the weighing sensor 510 sends a corresponding weighing signal based on the amount of elastic deformation and realizes measurement of the weight of the cooker body.

According to some embodiments of the present disclosure, the cantilever weighing portion 512 includes a first cantilever 5121 and a second cantilever 5122. The first cantilever 5121 is T-shaped and includes a transverse section 5121a and a longitudinal section 5121b, the longitudinal section 5121b is connected with the body portion 511, and two ends of the transverse section 5121a are separately provided with the second cantilever 5122. Specifically, referring to FIG. 2, the longitudinal section 5121b has a first end connected with the body portion 511 and a second end connected with a middle portion of the transverse section 5121a; two ends of the transverse section 5121a are connected with two second cantilevers 5122 respectively; the second cantilever 5122 is provided with a mounting hole for fixed connection with the support leg 520, and a screw 530 passes through the second cantilever 5122 and the support leg 520 to fix the support leg 520 on the cantilever weighing portion 512.

Therefore, after the cooker body is placed on the base 100, the body portion 511 moves downwards under the action of the gravity of the cooker body, and drives the longitudinal section 5121b to move and produce elastic deformation with respect to the transverse section 5121a and the second cantilever 5122. The cantilever weighing portion 512 with the above structure can produce the elastic deformation easily and have high sensitivity of weight sensing, and the deformation of the cantilever weighing portion 512 is distributed more evenly, resulting in a more accurate detection result.

In some embodiments, the body portion 511 includes a first frame bar 5111, a second frame bar 5112, a third frame bar 5113, and a fourth frame bar 5114 connected successively. The first frame bar 5111 is adjacent to the transverse section 5121a. The first frame bar 5111, the second frame bar 5112, the third frame bar 5113, and the fourth frame bar 5114 are apt to abut against the first support plate 131, the second support plate 132, the third support plate 133, and the fourth support plate 134 respectively.

In a specific embodiment shown in FIG. 2, the first frame bar 5111 and the third frame bar 5113 are opposite, while the second frame bar 5112 and the fourth frame bar 5114 are opposite. An inner edge of the first frame bar 5111 is adjacent to the transverse section 5121a of the cantilever weighing portion 512, an inner edge of the third frame bar 5113 is connected with the longitudinal section 5121b of the cantilever weighing portion 512, an inner edge of the second frame bar 5112 is adjacent to one of the second cantilevers 5122, and an inner edge of the fourth frame bar 5114 is adjacent to the other second cantilever 5122.

Thus, the structure of the cantilever weighing portion 512 is more compact, which shortens the volume of the weighing sensor 510, saves a mounting space of the weighing-device mounting groove 120, and hence makes the structure of the split electric rice cooker more compact.

According to some embodiments of the present disclosure, the first support plate 131 has an inverted three-step structure, and the third support plate 133 has an inverted two-step structure. The first frame bar 5111 is apt to abut against a bottom surface of a second step of the first support plate 131; the transverse section 5121a is suspended below a bottom surface of a first step 1311 of the first support plate 131; the first step 1311 of the first support plate 131 constitutes the limiting plate 160; and the third frame bar 5113 is apt to abut against a bottom surface of a first step 1331 of the third support plate 133.

Specifically, as illustrated in FIG. 2, a third step 1313 of the first support plate 131 is connected with the first side wall 121 of the weighing-device mounting groove 120; the third step 1313, the second step 1312 and the first step 1311 are arranged successively from outside to inside; and a clearance space is defined below the first step 1311 and at an inner side of the second step 1312. A second step 1332 of the third support plate 133 is connected with the third side wall 123 of the weighing-device mounting groove 120, and the second step 1332 and the first step 1331 are arranged successively from outside to inside.

Therefore, an upper surface of the first frame bar 5111 of the body portion 511 of the weighing sensor 510 abuts against the second step 1312 of the first support plate 131, and an upper surface of the third frame bar 5113 of the body portion 511 abuts against the first step 1331 of the third support plate 133; meanwhile, respective upper surfaces of the second frame bar 5112 and the fourth frame bar 5114 of the body portion 511 abut against the vertical snapping plate 140, such that they cooperate with one another to realize vertical position-limiting of the weighing sensor 510.

According to some embodiments of the present disclosure, the bottom surface of the second step 1312 of the first support plate 131 is flush with the bottom surface of the first step 1331 of the third support plate 133. Thus, the body portion 511 of the weighing sensor 510 is in a horizontal state after assembled with various support plates and is subject to a more balanced force, and the support from the support leg 520 connected with the weighing sensor 510 is more stable.

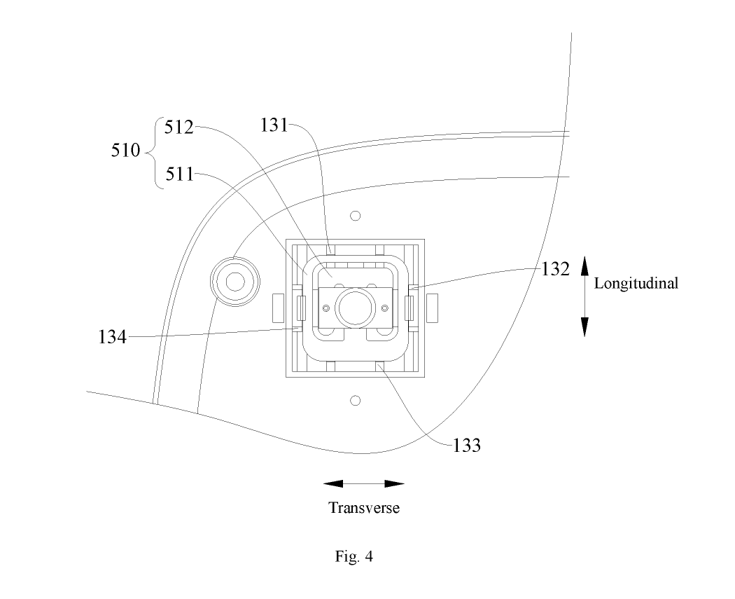

Combining FIG. 2 and FIG. 4, the third step 1313 of the first support plate 131 and the second step 1332 of the third support plate 133 clamp and respectively abut against the first frame bar 5111 and the third frame bar 5113, so as to limit the position of the body portion 511 in a direction parallel to the longitudinal section 5121b. Specifically, the first frame bar 5111 and the third frame bar 5113 are opposite in a longitudinal direction, a side surface of the third step 1313 of the first support plate 131 abuts against an outer edge of the first frame bar 5111, and a side surface of the second step 1332 of the third support plate 133 abuts against an outer edge of the third frame bar 5113. Thus, the body portion 511 is limited in the longitudinal direction and prevented from shaking in the longitudinal direction.

Referring to FIG. 2, a bottom surface of the third step 1313 of the first support plate 131 and a bottom surface of the second step 1332 of the third support plate 133 are both configured as a guide bevel. Specifically, the guide bevel gradually extends outwards from up to down. Thus, the provision of the guide bevel facilitates the installation of the weighing sensor 510 and makes the installation more convenient.

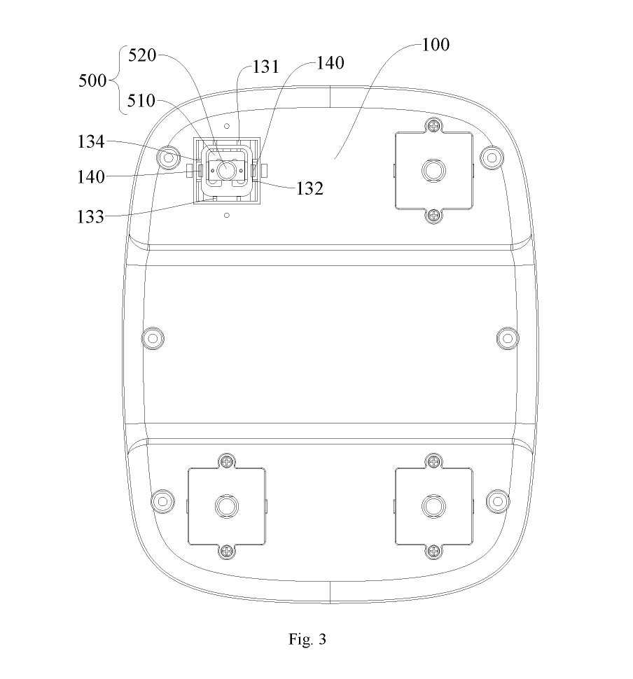

Further, referring to FIGS. 3 and 4, the second support plate 132 and the fourth support plate 134 are respectively located outside the second cantilevers 5122 of the corresponding sides to evade the second cantilevers 5122. Specifically, a clearance groove is defined between the outside of the second cantilever 5122 and the body portion 511. Thus, the relative deformation between the cantilever weighing portion 512 and the body portion 511 is smooth and unimpeded, to avoid a phenomenon of jamming, thereby improving the operational stability and reliability of the split electric rice cooker.

According to some embodiments of the present disclosure, as shown in FIG. 2, a limiting protrusion 135 is provided on each of the second support plate 132 and the fourth support plate 134, and the limiting protrusion 135 on the second support plate 132 and the limiting protrusion 135 on the fourth support plate 134 clamp and respectively abut against the second frame bar 5112 and the fourth frame bar 5114, so as to limit the position of the body portion 511 in a direction parallel to the transverse section 5121a.

Specifically, the second frame bar 5112 and the fourth frame bar 5114 are opposite in a transverse direction, the limiting protrusion 135 of the second support plate 132 abuts against an outer edge of the second frame bar 5112, and the limiting protrusion 135 of the fourth support plate 134 abuts against an outer edge of the fourth frame bar 5114, thereby achieving the position-limiting of the body portion 511 in the transverse direction.

In one embodiment, each of the second support plate 132 and the fourth support plate 134 is divided into two sections spaced apart from each other, and one vertical snapping plate 140 is disposed between the two sections. An inner side of the vertical snapping plate 140 may abut against or be spaced apart from the corresponding support plate. Thus, a snapping force and a clamping force distributed on the body portion 511 can be distributed more evenly, thereby avoiding concentrated distribution of stress on the body portion 511.

In some embodiments, the bottom of the base 100 is further provided with an catching groove 150, the press cover 600 is further provided with a pre-assembled catching portion 602, and the pre-assembled catching portion 602 is engaged within the catching groove 150. Referring to FIG. 2, the press cover 600 is in a substantially square shape, and two opposite edges of the press cover 600 are provided with the pre-assembled catching portions 602. Correspondingly, the shape of the weighing-device mounting groove 120 is consistent with that of the press cover 600. The catching groove 150 is located at an outer side of the weighing-device mounting groove 120 and in one-to-one correspondence to the pre-assembled catching portion 602. During the assembly, the pre-assembled catching portion 602 of the press cover 600 is engaged in the catching groove 150 of the base 100 to implement the pre-assembly of the press cover 600.

Certainly, the number of the pre-assembled catching portion 602 and the catching groove 150 is not limited to two illustrated in FIG. 2, but may be more than two.

In order to enhance the tightness and reliability of the connection between the press cover 600 and the base 100, the press cover 600 can be fastened to the bottom of the base 100 through a press-cover threaded assembly 703. Specifically, each of the other two opposite edges of the press cover 600 is provided with a mounting ear having a mounting hole, the base 100 has a threaded hole corresponding to the mounting hole, and a screw of the press-cover threaded assembly 703 passes through the mounting hole and is tightly fitted with the threaded hole to fasten the press cover 600 on the base 100.

In a specific embodiment illustrated in FIG. 5, a distance between the cantilever weighing portion 512 and the limiting plate 160 is L, the deformation displacement of the cantilever weighing portion 512 with respect to the body portion 511 is associated with the weight to be weighed, and the deformation displacement of the cantilever weighing portion 512 is S when the weighing sensor 510 is in a maximum range, in which L≤S. Thus, it is possible to provide better overload protection for the weighing sensor 510, to avoid the occurrence of the phenomenon that the weighing sensor 510 fails because of exceeding the range during operation.

In a specific embodiment illustrated in FIG. 1, the press cover 600 is provided with the press-cover clearance hole 601 for the support leg 520 to pass downwards.

Certainly, the present disclosure is not limited thereto, and the press cover 600 can be connected with the support leg 520. For example, in a specific embodiment illustrated in FIG. 7, the press cover 600 and the support leg 520 are integrally formed, and the support leg 520 is supported on a bottom surface of the cantilever weighing portion 512, and can be deformed along with the press cover 600 and push the cantilever weighing portion 512 upwards.

Thus, when the cooker body is mounted onto the base 100, the weighing sensor 510 is deformed under the action of gravity of the cooker body, such that the base 100 is able to weigh the cooker body and hence judges whether the cooker body matches it based on a weighing result, thereby improving accuracy of matching the base 100 with the cooker body. Additionally, by sealing the weighing sensor 510 in the weighing-device mounting groove 120 through the press cover 600, not only the weighing sensor 510 can be protected well, but also the split electric rice cooker has a more beautiful appearance.

According to some embodiments of the present disclosure, the press cover 600 is provided with a weakening structure. It could be understood that the weakening structure means weakening the rigidity of the press cover 600 to make the press cover 600 more easily deformed. Thus, when the cooker body is mounted on the base 100, the press cover 600 having the weakening structure is more easily deformed and generates a larger amount of deformation. In such a way, the pushing force of the press cover 600 on the cantilever weighing portion 512 is greater, which improves the sensitivity of the weighing device 510 and the accuracy of the measurement result.

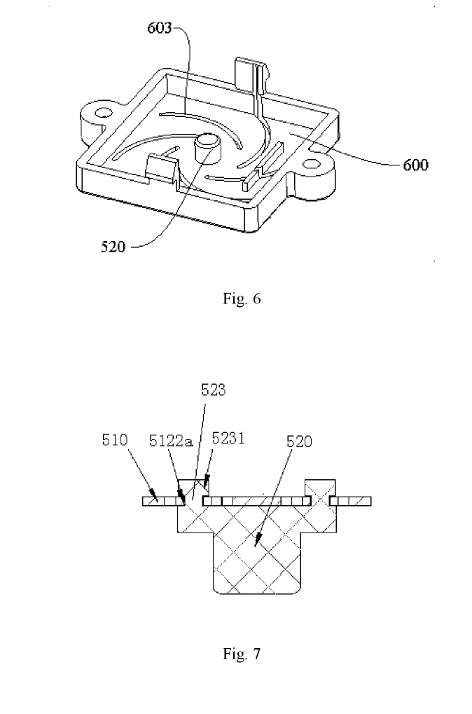

In a specific embodiment illustrated in FIG. 6, the weakening structure is a weakening groove 603 penetrating the press cover 600. Thus, by providing the weakening groove 603 in the press cover 600, it is possible to weaken the rigidity of the press cover 600, save materials, and reduce costs.

In some embodiments, as illustrated in FIG. 7, the weighing sensor 510 is provided with a mounting hole 5122a; an upper surface of the support leg 520 is fixed with a fixing column 523; the fixing column 523 is provided through the mounting hole 5122a, and an upper end of the fixing column 523 is formed with a diameter-enlarged portion 5231; and a radial dimension of the diameter-enlarged portion 5231 is larger than a radial dimension of the mounting hole 5122a, such that the weighing sensor 510 is clamped and fixed between the diameter-enlarged portion 5231 and the support leg 520.

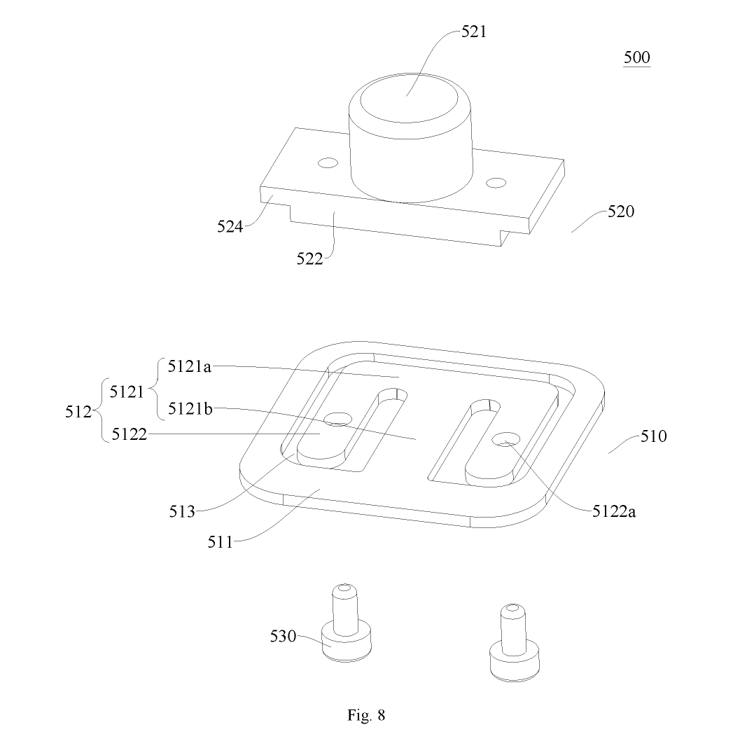

A split electric rice cooker according to embodiments of the present disclosure will be described in detail with reference to FIG. 8 to FIG. 14.

As illustrated in FIG. 8, a weighing device 500 according to embodiments of the present disclosure includes a weighing sensor 510, a support leg 520 and a limiting portion 524. The weighing sensor 510 includes a body portion 511 and a cantilever weighing portion 512, and the cantilever weighing portion 512 is provided to the body portion 511. The support leg 520 is supported on a bottom surface of the cantilever weighing portion 512 and fixed with the cantilever weighing portion 512. The limiting portion 524 is provided to the support leg 520 and located below the body portion 511, and the limiting portion 524 is apt to move upwards along with the support leg 520 with respect to the body portion 511 so as to abut against a bottom surface of the body portion 511.

For the weighing device 500 according to the embodiments of the present disclosure, the body portion 511 moves downwards with respect to the cantilever weighing portion 512, the support leg 520 and the limiting portion 524 under the gravity of an object to be weighed, that is, the support leg 520 and the limiting portion 524 together move upwards with respect the body portion 511. When the object to be weighed reaches a preset value, the limiting portion 524 abuts against the bottom surface of the body portion 511, to prevent the cantilever weighing portion 512 of the weighing sensor 510 from being excessively deformed and thus from generating an unrecoverable plastic deformation. Therefore, it is possible to avoid the failure of the weighing sensor 510 due to overloading, and prolong the service life of the weighing sensor 510.

It should be noted that only when the weight applied to the body portion 511 exceeds a tolerable range of the weighing sensor 510, the limiting portion 524 abuts against the bottom surface of the body portion 511; when the weighing sensor 510 is in normal use, the limiting portion 524 moves towards the body portion 511 and remains at a certain balanced position, in which case the limiting portion 524 is spaced apart from the bottom surface of the body portion 511 by a certain distance. Thus, it is possible to avoid the failure of the weighing sensor 510 due to overloading and at the same time guarantee the normal use of the weighing sensor 510.

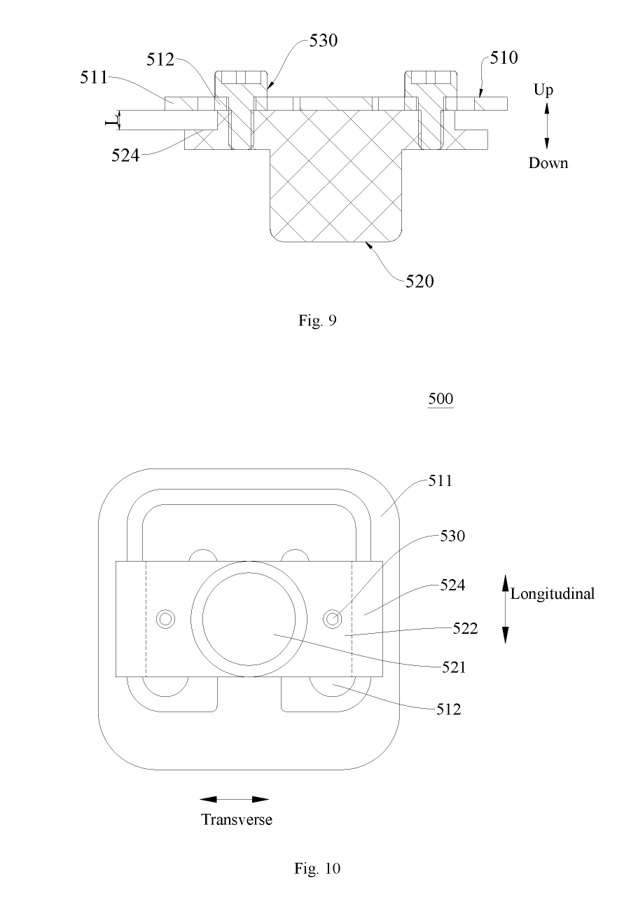

In a specific embodiment illustrated in FIG. 9, a distance between the limiting portion 524 and the body portion 511 is L, the deformation displacement of the cantilever weighing portion 512 with respect to the body portion 511 is associated with the weight to be weighed, and the deformation displacement of the cantilever weighing portion 512 is S when the weighing sensor 510 is in a maximum range, in which L≤S. That is, the maximum allowable deformation amount of the cantilever weighing portion 512 which guarantees the normal operation of the weighing sensor 510 is S, and in this embodiment the maximum deformation amount of the cantilever weighing portion 512 is L, such that the weighing sensor 510 can always be controlled within the working range.

In some embodiments, the body portion 511 is an annular frame body, and the cantilever weighing portion 512 is provided inside the body portion 511. Specifically, as illustrated in FIG. 8, the cantilever weighing portion 512 is provided inside the body portion 511 and fixedly connected with an inner edge of the body portion 511; the support leg 520 and the cantilever weighing portion 512 are opposite in an up-and-down direction and fixedly connected; the limiting portion 524 is connected to an outer side of the support leg 520 and is opposite to the body portion 511 in the up-and-down direction. Thus, the weighing sensor 510 occupies a smaller space and has a more compact structure.

Referring to FIG. 8, the cantilever weighing portion 512 includes a first cantilever 5121 and a second cantilever 5122. The first cantilever 5121 is fixed with the body portion 511, and the second cantilever 5122 is fixed with the first cantilever 5121 and is also fixed with the support leg 520. Further, the second cantilever 5122 is separately located at two sides of the first cantilever 5121. That is, two second cantilevers 5122 are provided, and the two second cantilevers 5122 are connected to two transverse sides of the first cantilever 5121 respectively. Thus, the cantilever weighing portion 512 is more evenly stressed, thereby avoiding being damaged by stress concentration.

Further, the first cantilevers 5121 at two sides of the second cantilever 5122 are arranged symmetrically, and the first cantilever 5121 is spaced apart from and arranged parallel to the second cantilever 5122. Thus, the structure of the weighing sensor 510 is more compact.

In one embodiment, the first cantilever 5121 is T-shaped and includes a transverse section 5121a and a longitudinal section 5121b, and two ends of the transverse section 5121a are separately provided with the second cantilever 5122. Specifically, referring to FIG. 9, the longitudinal section 5121b has a first end connected with the body portion 511 and a second end connected with a middle portion of the transverse section 5121a; two ends of the transverse section 5121a are connected with two second cantilevers 5122 respectively. Thus, when the body portion 511 moves downwards under the action of the object to be weighed, the support leg 520 and the second cantilever 5122 are stationary, and hence relative displacement between the second cantilever 5122 and the body portion 511 is generated. In such a case, the longitudinal section 5121b of the first cantilever 5121 generates elastic deformation under the action of the relative movement between the body portion 511 and the support leg 520, whereby the weighing sensor 510 can measure the weight of the object based on the deformation amount.

Certainly, the present disclosure is not limited thereto, and the shape of the cantilever weighing portion 512 is not limited to the shape illustrated in FIG. 1, but can be U-shaped, T-shaped, V-shaped or the like. In one embodiment, the shape of the cantilever weighing portion 512 and the body portion 511 as needed.

Referring to FIG. 8, the support leg 520 includes a support-leg body 521 and a support block 522 provided to the support-leg body 521, and the support block 522 is fixed with the second cantilever 5122. Further, respective lower surfaces of the first cantilever 5121 and the second cantilever 5122 are flush with each other, and abut against an upper surface of the support block 522. Thus, it is possible to ensure the tightness and stability of connection between the first cantilever 5121 and the support block 522, and provide sufficient space for the deformation of the first cantilever 5121.

In some embodiments, the second cantilever 5122 is provided with a mounting hole 5122a; the weighing device 500 further includes a weighing-device threaded fastener 530; and the weighing-device threaded fastener 530 is fixed by being threaded with the support block 522 after passing through the mounting hole 5122a from the top downwards. Thus, when the weighing sensor 510 goes wrong, it is more convenient to disassemble and repair.

As illustrated in FIG. 10, a distance between facing-away outer sides of the two second cantilevers 5122 is greater than or equal to a transverse length of the support block 522. Thus, the body portion 511 is prevented from interfering with an edge of the support block 522 when the cantilever weighing portion 512 moves with respect to the body portion 511 during the weighing, and hence a phenomenon of jamming during the weighing is avoided, thereby enhancing the operational reliability and stability of the weighing device 500.

In some embodiments, the limiting portion 524 is provided to an end face of each of two transverse ends of the support block 522. Thus, better protection of the weighing sensor 510 can be achieved. Certainly, the present disclosure is not limited thereto, and for example, in some other embodiments, the limiting portion 524 can be provided to an end face of each of two longitudinal ends of the support block 522.

A hollowed groove 513 is defined between the body portion 511 and the second cantilever 5122, and an outer side surface of the limiting portion 524 is outside an outer edge of the hollowed groove 513, as illustrated in FIG. 1. Thus, the cantilever weighing portion 512 adopting the above structure can produce the elastic deformation more easily and have high sensitivity of weight sensing, and the deformation of the cantilever weighing portion 512 is distributed more evenly, resulting in a more accurate detection result.

It could be understood that the weighing device 500 according to the embodiments of the present disclosure can be applied to the split electric rice cooker, and the weighing device 500 is provided to the base of the split electric rice cooker to measure the weight of the cooker body, thereby achieve proper match between the cooker body and the base.

A split electric rice cooker 1000 according to embodiments of the present disclosure includes the above weighing device 500 according to the above embodiments. The split electric rice cooker 1000 can avoid the failure of the weighing sensor 510 due to overloading and prolong the service life of the weighing sensor 510, resulting in good product quality.

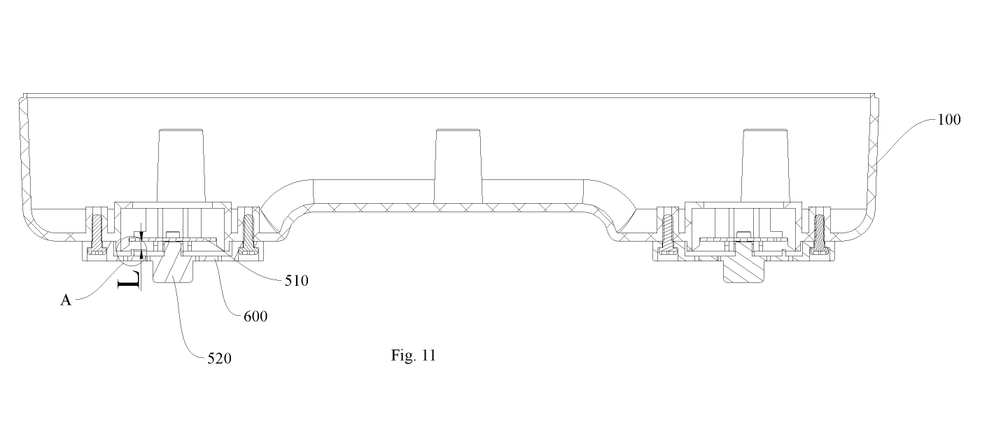

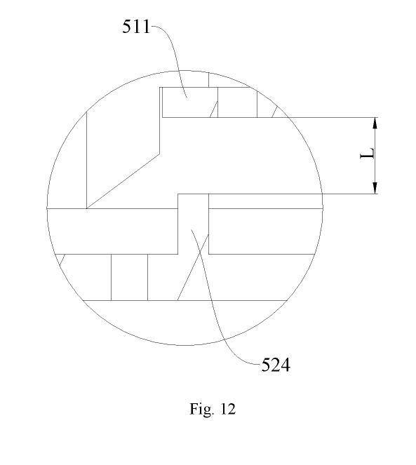

Referring to FIGS. 11 and 12, in some embodiments, the split electric rice cooker further includes a base 100, a cooker body 200, and a press cover 600. The base 100 is provided with a weighing-device mounting groove 120 at the bottom thereof, and the weighing sensor 510 is fixed in the weighing-device mounting groove 120. The cooker body 200 is apt to rest on the base 100 and is separable with respect to the base 100. The press cover 600 is provided at the bottom of the base 100 and shields the weighing-device mounting groove 120, and the press cover 600 is integrally provided with a support leg 520. The support leg 520 is supported on a bottom surface of the cantilever weighing portion 512, and can be deformed along with the press cover 600 and push the cantilever weighing portion 512 upwards.

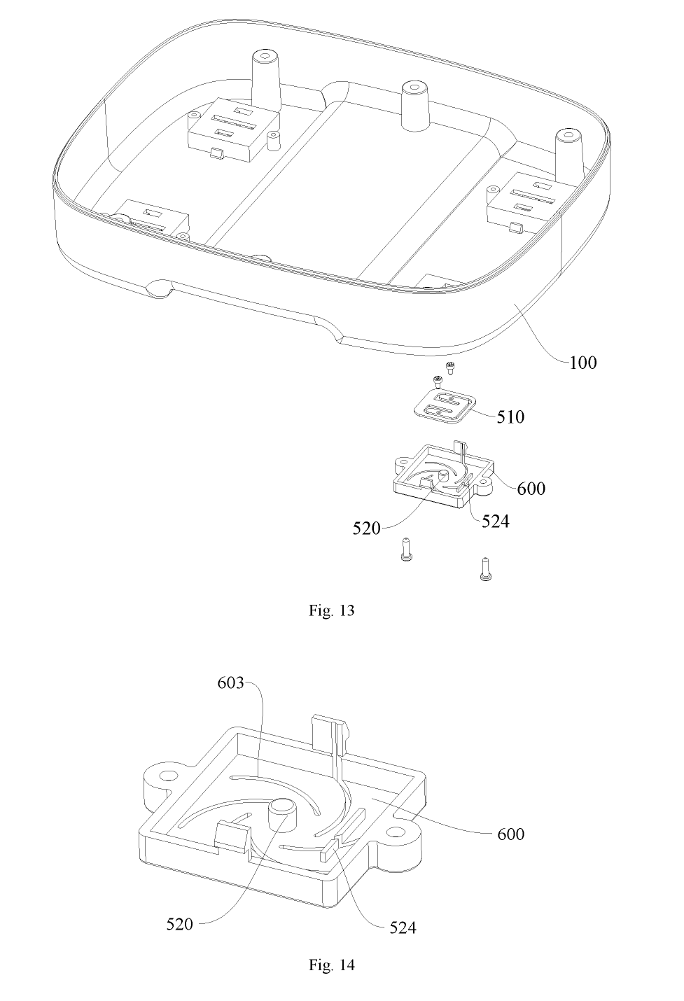

Further referring to FIGS. 13 and 14, the limiting portion 524 is provided to the entirety formed by the press cover 600 and the support leg 520, and the limiting portion 524 can be located on an upper surface of a bottom wall of the press cover. By configuring the press cover 600 and the support leg 520 into an integral structure, and enabling the support leg 520 under pressure to move upwards relative to the base 100 and hence push the cantilever weighing portion 512 to deform the cantilever weighing portion 512, the weighing device 510 can obtain a corresponding weight change value based on the deformation amount of the cantilever weighing portion 512, and in such a way, the weight measurement of the cooker body is implemented. Due to the integral structure of the press cover 600 and the support leg 520, the assembly procedure is simplified, the production cost is saved, and the split electric rice cooker has a more compact structure and is more convenient to assemble.

According to some embodiments of the present disclosure, the press cover 600 is provided with a weakening structure. It could be understood that the weakening structure means weakening the rigidity of the press cover 600 to make the press cover 600 more easily deformed. Thus, when the cooker body is mounted on the base 100, the press cover 600 having the weakening structure is more easily deformed and generates a larger amount of deformation. In such a way, the pushing force of the press cover 600 on the cantilever weighing portion 512 is greater, which improves the sensitivity of the weighing device 510 and the accuracy of the measurement result.

In a specific embodiment illustrated in FIG. 14, the weakening structure is a weakening groove 603 penetrating the press cover 600. Thus, by providing the weakening groove 603 in the press cover 600, it is possible to weaken the rigidity of the press cover 600, save materials, and reduce costs.

Certainly, the present disclosure is not limited thereto, and the press cover 600 may not be connected with the support leg 520. For example, in the specific embodiment illustrated in FIG. 1, the press cover 600 is provided with a press-cover clearance hole 601 for the support leg 520 to pass downwards.

Thus, when the cooker body is mounted on the base 100, the weighing sensor 510 is deformed under the action of gravity of the cooker body, and the base 100 is able to weigh the cooker body and hence judges whether the cooker body matches it based on a weighing result, thereby improving accuracy of matching the base 100 with the cooker body. Additionally, by sealing the weighing sensor 510 in the weighing-device mounting groove 120 through the press cover 600, not only the weighing sensor 510 can be protected better, but also the split electric rice cooker has a more beautiful appearance.

In some embodiments, as illustrated in FIG. 7, the weighing sensor 510 is provided with a mounting hole 5122a; an upper surface of the support leg 520 is fixed with a fixing column 524; the fixing column 524 is provided through the mounting hole 5122a, and an upper end of the fixing column 524 is formed with a diameter-enlarged portion 5231; and a radial dimension of the diameter-enlarged portion 5231 is larger than a radial dimension of the mounting hole 5122a, such that the weighing sensor 510 is clamped and fixed between the diameter-enlarged portion 5231 and the support leg 520.

In the specification, it is to be understood that terms such as “central,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise” “axially,” “radially,” and “circumferentially” should be construed to refer to the orientation as then described or as shown in the drawings under discussion. These relative terms are for convenience of description, and do not indicate or imply that the present disclosure have a particular orientation or be constructed or operated in a particular orientation, thus should not be construed to limit the present disclosure.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present disclosure, “a plurality of” means two or more than two, unless specified otherwise.

In the present disclosure, unless specified or limited otherwise, the terms “mounted,” “connected,” “coupled,” “fixed” and the like are used broadly, and may be, for example, fixed connections, detachable connections, or integral connections; may also be mechanical or electrical connections; may also be direct connections or indirect connections via intervening structures; may also be inner communications of two elements.

In the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the appearances of the phrases in various places throughout this specification are not necessarily referring to the same embodiment or example of the present disclosure. Furthermore, the particular features, structures, materials, or characteristics may be combined in any suitable manner in one or more embodiments or examples.

What is claimed is:

1. A split electric rice cooker, comprising:
a base provided with a weighing-device mounting groove at a bottom thereof;
a cooker body apt to rest on the base and separable with respect to the base;
a weighing device provided in the weighing-device mounting groove, and comprising a weighing sensor and a support leg connected with the weighing sensor, the weighing sensor being fixed in the weighing-device mounting groove and comprising a body portion and a cantilever weighing portion, the cantilever weighing portion being provided to the body portion;
a press cover provided to the bottom of the base and shielding the weighing-device mounting groove, in which the support leg penetrates downwards through the press cover;
wherein a limiting plate is provided in the weighing-device mounting groove, the cantilever weighing portion is located below the limiting plate, and when the cantilever weighing portion is bent upwards and deformed with respect to the body portion, the limiting plate is apt to abut against the cantilever weighing portion to limit a position of the cantilever weighing portion; or the support leg is provided with a limiting portion, the limiting portion is located below the body portion, and the limiting portion is apt to move upwards with respect to the body portion along with the support leg to abut against a bottom surface of the body portion.

2. The split electric rice cooker according to claim 1, wherein a support plate and a vertical snapping plate are provided in the weighing-device mounting groove, and the weighing sensor is sandwiched between the vertical snapping plate and the support plate.

3. The split electric rice cooker according to claim 2, wherein the support plate comprises a first support plate, a second support plate, a third support plate, and a fourth support plate; the first support plate, the second support plate, the third support plate, and the fourth support plate are provided to a first side wall, a second side wall, a third side wall and a fourth side wall of the weighing-device mounting groove respectively; the first side wall, the second side wall, the third side wall and the fourth side wall are connected successively.

4. The split electric rice cooker according to claim 1, wherein the body portion is an annular frame body, and the cantilever weighing portion is provided within the body portion.

5. The split electric rice cooker according to claim 4, wherein the cantilever weighing portion comprises a first cantilever and a second cantilever; the first cantilever is T-shaped and comprises a transverse section and a longitudinal section; the longitudinal section is connected with the body portion, and two ends of the transverse section are separately provided with the second cantilever.

6. The weighing device according to claim 4, wherein the cantilever weighing portion comprises a first cantilever and a second cantilever; the first cantilever is fixed with the body portion; the second cantilever is fixed with the first cantilever and also fixed with the support leg.

7. The weighing device according to claim 6, wherein the second cantilever is located at each of two sides of the first cantilever.

8. The split electric rice cooker according to claim 5, wherein the body portion comprises: a first frame bar, a second frame bar, a third frame bar, and a fourth frame bar connected successively; the first frame bar is adjacent to the transverse section; the first frame bar, the second frame bar, the third frame bar, and the fourth frame bar are apt to abut against the first support plate, the second support plate, the third support plate, and the fourth support plate respectively.

9. The split electric rice cooker according to claim 8, wherein the first support plate has an inverted three-step structure;
the third support plate has an inverted two-step structure;
the first frame bar is apt to abut against a bottom surface of a second step of the first support plate; the transverse section is suspended below a bottom surface of a first step of the first support plate; the first step of the first support plate constitutes the limiting plate; and the third frame bar is apt to abut against a bottom surface of a first step of the third support plate.

10. The split electric rice cooker according to claim 1, wherein a distance between the cantilever weighing portion and the limiting plate is L, deformation displacement of the cantilever weighing portion with respect to the body portion is associated with the weight to be weighed, and the deformation displacement of the cantilever weighing portion is S when the weighing sensor is in a maximum range, in which L≤S.

11. The weighing device according to claim 1, wherein a distance between the limiting portion and the body portion is L, deformation displacement of the cantilever weighing portion with respect to the body portion is associated with the weight to be weighed, and the deformation displacement of the cantilever weighing portion is S when the weighing sensor is in a maximum range, in which L≤S.

12. The weighing device according to claim 5, wherein the support leg comprises a support-leg body and a support block provided to the support-leg body, the support block being fixed with the second cantilever.

13. The weighing device according to claim 12, wherein respective lower surfaces of the first cantilever and the second cantilever are flush with each other, and both abut against an upper surface of the support block.

14. The weighing device according to claim 12, wherein the second cantilever is provided with a mounting hole;
the weighing device further comprises a weighing-device threaded fastener, and the weighing-device threaded fastener is fixed by being threaded with the support block after passing through the mounting hole from the top downwards.

15. The weighing device according to claim 12, wherein a distance between facing-away outer sides of the two second cantilevers is greater than or equal to a transverse length of the support block.

16. The weighing device according to claim 12, wherein the limiting portion is provided to an end face of each of two transverse ends of the support block.

17. The weighing device according to claim 16, wherein a hollowed groove is defined between the body portion and the second cantilever, and an outer side surface of the limiting portion is outside an outer edge of the hollowed groove.

18. The weighing device according to claim 5, wherein the second cantilevers at two sides of the first cantilever are arranged symmetrically, and the first cantilever is spaced apart from and arranged parallel to the second cantilever.

19. The split electric rice cooker according to claim 1, wherein the press cover and the support leg are integrally formed, and the support leg is supported on a bottom surface of the cantilever weighing portion and is able to be deformed along with the press cover and push the cantilever weighing portion upwards; or
the press cover is provided with a press-cover clearance hole for the support leg to pass downwards.

20. The split electric rice cooker according to claim 1, wherein the weighing sensor is provided with a mounting hole, an upper surface of the support leg is fixed with a fixing column, the fixing column is provided through the mounting hole and has an upper end formed with a diameter-enlarged portion, and a radial dimension of the diameter-enlarged portion is larger than a radial dimension of the mounting hole, such that the weighing sensor is clamped and fixed between the diameter-enlarged portion and the support leg.
